(19) United States
(12) Patent Application Publication
(10) Pub. No.: US 2025/0332829 A1
(43) Pub. Date: Oct. 30, 2025

(54) INKJET RECORDING APPARATUS

(71) Applicant: KYOCERA Document Solutions Inc., Osaka (JP)

(72) Inventors: Masato USUI, Osaka (JP); Hiroomi NAKATSUJI, Osaka (JP); Naoko KAWASHIMA, Osaka (JP); Jun NAKANO, Osaka (JP)

(73) Assignee: KYOCERA Document Solutions Inc., Osaka (JP)

(21) Appl. No.: 19/186,190

(22) Filed: Apr. 22, 2025

(30) Foreign Application Priority Data
Apr. 25, 2024 (JP) 2024-071842

(51) Int. Cl. B41J 2/045; B41J 2/21

(52) U.S. Cl. CPC B41J 2/04508; B41J 2/2139; B41J 2/2142; B41J 2/04586

(57) ABSTRACT

In the inkjet recording apparatus, for correction of a faulty nozzle of recording heads, the controller changes quantity of ink ejection to corrective pixel areas adjacent in an intersectional direction to a faulty pixel area corresponding to the faulty nozzle. A quantity of ink ejection to the corrective pixel areas involved in a case where ink drops have already been ejected to adjoining pixel areas oppositely adjacent to the faulty pixel area with the corrective pixel areas interposed therebetween in the intersectional direction is larger than a quantity of ink ejection to the corrective pixel areas involved in a case where ink drops have not yet been ejected to the adjoining pixel areas.

### INCORPORATION BY REFERENCE

This application is based on and claims the benefit of priority from Japanese Patent Application No. 2024-071842 filed on Apr. 25, 2024, the contents of which are hereby incorporated by reference.

### BACKGROUND

The present disclosure relates to an inkjet recording apparatus.

A conventional inkjet recording apparatus includes recording heads, a drive unit, and a controller. The recording heads eject ink onto a recording medium. The drive unit moves at least one of the recording medium and the recording heads. The controller controls relative movement of the recording medium and the recording heads to achieve recording onto the recording medium. Each recording head has a plurality of nozzles which are arrayed along an intersectional direction that intersects a relative movement direction of the recording head relative to the recording medium, and which differ in ink-drop ejection order thereamong.

For correction of faulty nozzles of a recording head, the controller decreases quantity of ink ejection to adjoining pixel areas that are adjacent in an intersectional direction to corrective pixel areas that are adjacent in an intersectional direction to faulty pixel areas to which ink drops are to be ejected by the faulty nozzles.

As a result of this, when ink ejection to corrective pixel areas occur later than ink ejection to adjoining pixel areas, ink drops to be ejected to the corrective pixel areas can be made less likely to be moved nearer to ink drops of the adjoining pixel areas due to ink-shot interference. Therefore, generation of white stripes in faulty pixel areas can be suppressed.

However, with conventional inkjet recording apparatuses, since the quantity of ink ejection to corrective pixel areas is constant, there has been a possibility that color stripes may occur in the corrective pixel areas. Due to this, it would be likely that image quality may deteriorate as attributable to correction of faulty nozzles.

In view of the above-described problems, the present disclosure has an objective of providing an inkjet recording apparatus capable of suppressing deteriorations of image quality.

### SUMMARY

An inkjet recording apparatus according to one aspect of the present disclosure includes a recording head, a drive unit, and a controller. The recording head ejects ink onto a recording medium. The drive unit moves at least one of the recording medium and the recording head. The controller controls relative movement of the recording medium and the recording head relative to each other to execute recording on the recording medium. The recording head includes a plurality of nozzles. The plural nozzles are arrayed along an intersectional direction intersecting a relative movement direction of the recording head relative to the recording medium, and the nozzles differ in ejection order of ink drops from one another. For correction of a faulty nozzle of the recording head, the controller changes quantity of ink ejection to corrective pixel areas adjacent in the intersectional direction to faulty pixel areas corresponding to the faulty nozzles. A quantity of ink ejection to the corrective pixel areas involved in a case where ink drops have already been ejected to adjoining pixel areas oppositely adjacent to the faulty pixel areas with the corrective pixel areas interposed therebetween in the intersectional direction is larger than a quantity of ink ejection to the corrective pixel areas involved in a case where ink drops have not yet been ejected to the adjoining pixel areas.

This and other objects of the present disclosure, and specific benefits obtained according to the present disclosure, will become more apparent from the description of embodiments which follows.

### BRIEF DESCRIPTION OF THE DRAWINGS

FIG. 1 is a cross-sectional view showing a schematic configuration of an inkjet recording apparatus 1 according to an embodiment of the disclosure;

FIG. 2 is a plan view of a recording part 5 of the inkjet recording apparatus 1 of FIG. 1;

FIG. 3 is a block diagram showing a schematic configuration of the inkjet recording apparatus 1 of FIG. 1;

FIG. 4 is an explanatory view showing ink ejection positions of the inkjet recording apparatus 1 according to the embodiment of the disclosure;

FIG. 5 is an explanatory view showing ink-drop positions on a paper sheet in the inkjet recording apparatus 1 according to the embodiment of the disclosure;

FIG. 6 is a flowchart showing an execution example of correction mode in the inkjet recording apparatus 1 according to the embodiment of the disclosure; and

FIG. 7 is a table collecting evaluation results of Example 1.

### DETAILED DESCRIPTION

### <1. Configuration of Inkjet Recording Apparatus>

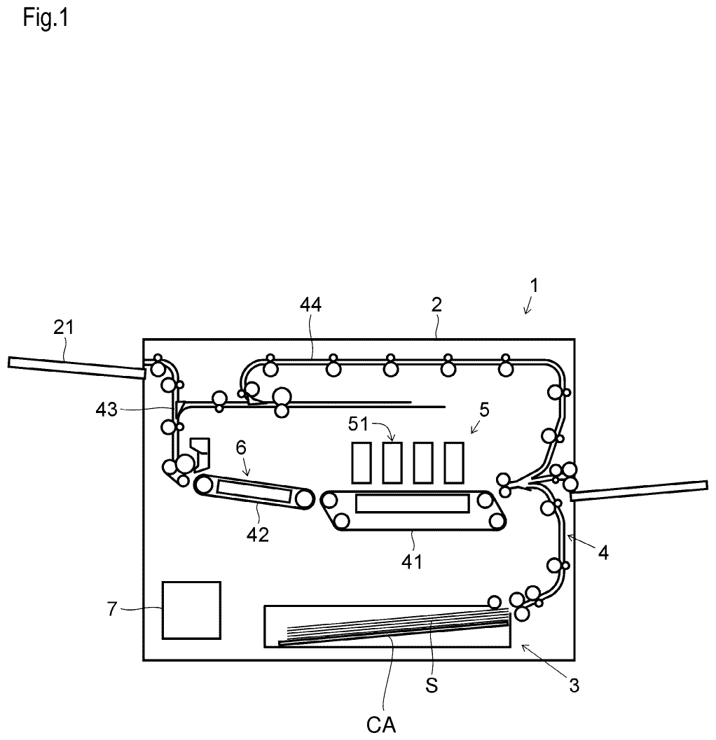

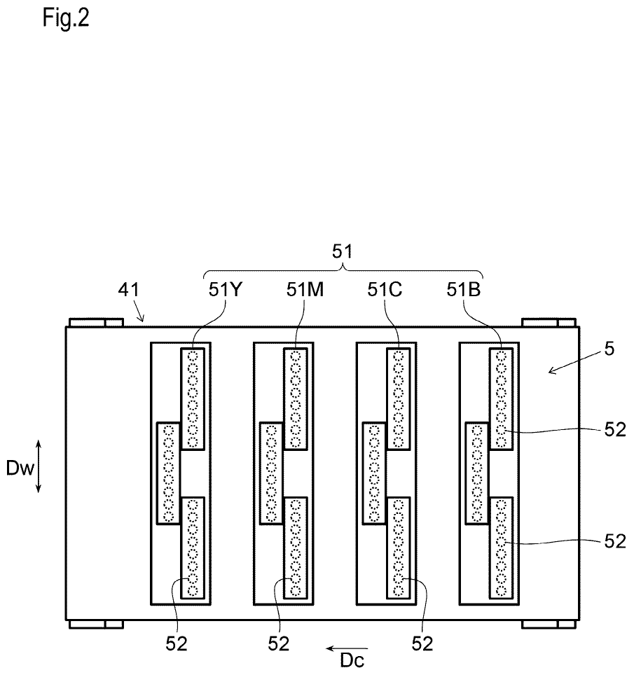

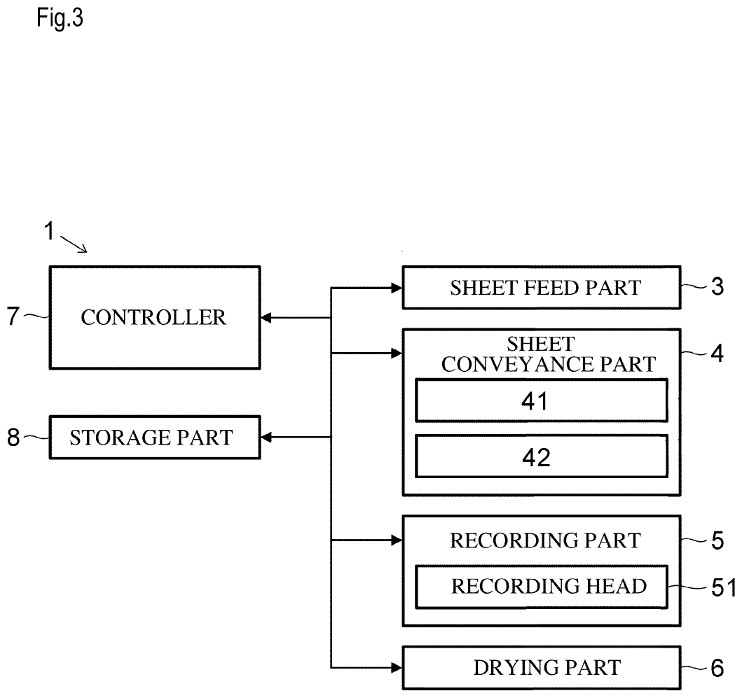

Hereinafter, an embodiment of the present disclosure will be described with reference to the accompanying drawings. FIG. 1 is a cross-sectional view showing a schematic configuration of an inkjet recording apparatus 1 according to the embodiment. FIG. 2 is a plan view of a recording part 5 of the inkjet recording apparatus 1 of FIG. 1. FIG. 3 is a block diagram showing a schematic configuration of the inkjet recording apparatus 1 of FIG. 1. The inkjet recording apparatus 1 is, for example, a printer of inkjet recording type. As shown in FIGS. 1, 2 and 3, the inkjet recording apparatus 1 includes an apparatus body 2, a sheet feed part 3, a sheet conveyance part 4, a recording part 5, a drying part 6, and a controller 7.

The sheet feed part 3, containing a plurality of paper sheets (recording medium) S, separates and feeds out those sheets S one by one during recording process. The sheet conveyance part 4 conveys a sheet S, which has been fed out from the sheet feed part 3, to the recording part 5 and the drying part 6, and discharges the sheet S, after its being recorded and dried, onto a sheet discharge part 21. In cases where double-sided recording is performed, the sheet conveyance part 4 directs the sheet S, which has been recorded on its first surface and dried, toward an inversion-and-conveyance part 44 by a branch part 43, followed by switchover of the conveyance direction, making the sheet S, which has been top-bottom inverted, conveyed once again to the recording part 5 and the drying part 6.

The sheet conveyance part 4 includes a first belt conveyance part 41 and a second belt conveyance part 42. The first belt conveyance part 41 and the second belt conveyance part 42 convey the sheet S while sucking and holding the sheet S on an upper surface of an endless belt. That is, the sheet conveyance part 4 serves as a driving part for moving the sheet (recording medium) S relative to the recording part 5.

The recording part 5 is placed above the first belt conveyance part 41, with a specified distance thereto, so as to be opposed to the sheet S being conveyed as it is sucked and held on the upper surface of the first belt conveyance part 41. The recording part 5 has recording heads 51 of line-type inkjet mode. The recording heads 51, as shown in FIG. 2, include recording heads 51B, 51C, 51M, 51Y corresponding to four colors of black, cyan, magenta, and yellow, respectively. In each group of the individual-color recording heads 51, a plurality (e.g., three) of recording heads are arrayed in a staggered arrangement along a sheet widthwise direction Dw perpendicular to a sheet conveyance direction Dc.

Plural nozzles 52 are enabled to eject ink drops over an entire recording region on the sheet S. M ore specifically, each recording head 51 has a plurality of nozzles 52 that differ in ink-drop ejection order from one another. The plural nozzles 52 are arrayed along an intersectional direction (sheet widthwise direction) Dw that intersects a relative movement direction (sheet conveyance direction) Dc of the recording heads 51 relative to the sheet (recording medium).

The recording part 5 ejects ink sequentially from the four-color recording heads 51B, 51C, 51M, 51Y toward the sheet S being conveyed by the first belt conveyance part 41, thus recording a full-color image or monochrome image on the sheet S.

The drying part 6 is placed downstream of the recording part 5 in the sheet conveyance direction, and has the second belt conveyance part 42 provided therein. The sheet S, on which an ink image has been recorded in the recording part 5, undergoes ink drying while being conveyed in the drying part 6 as it is sucked and held by the second belt conveyance part 42.

The controller 7 includes an unshown CPU as well as other electronic circuits and electronic components. Based on control-dedicated programs and data stored in a storage part 8, the CPU performs processing related to functions of the inkjet recording apparatus 1 by controlling operations of the component elements provided in the inkjet recording apparatus 1. The sheet feed part 3, the sheet conveyance part 4, the recording part 5, and the drying part 6, upon receiving instructions individually from the controller 7, perform recording on the sheet S in linkage with one another.

The storage part 8 consists of nonvolatile storage devices exemplified by unshown program ROM (Read Only Memory), data ROM, or the like, and volatile storage devices exemplified by RAM (Random Access Memory) or the like, in combination of these devices.

The controller 7 controls relative movement of the sheet S and the recording heads 51 to execute recording on the sheet S. In more detail, the controller 7 controls the recording heads 51 so as to make the nozzles 52 individually eject liquid quantities of ink corresponding to pixel values of image data, respectively, toward the sheet S. As a result, an image is formed on the sheet S. In this embodiment, the relative movement direction of the recording heads 51 relative to the sheet S is the sheet conveyance direction Dc.

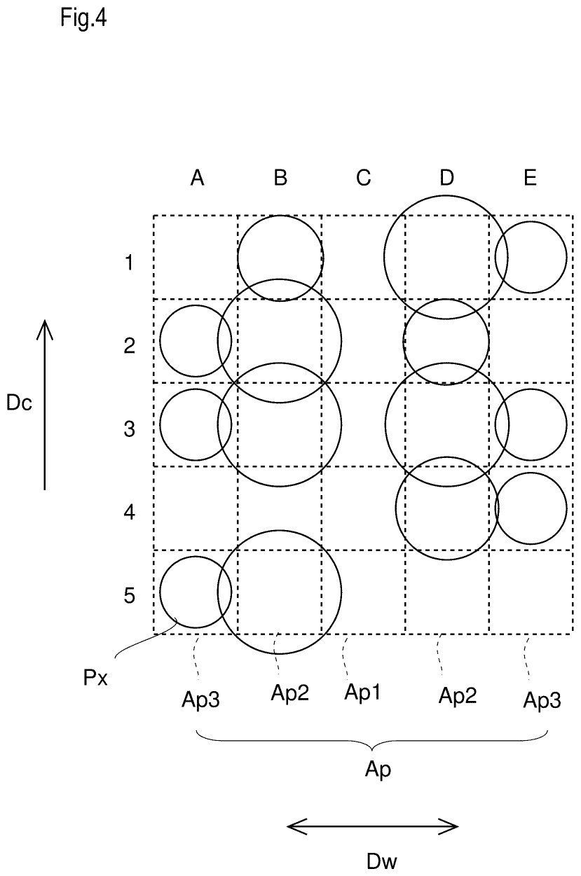

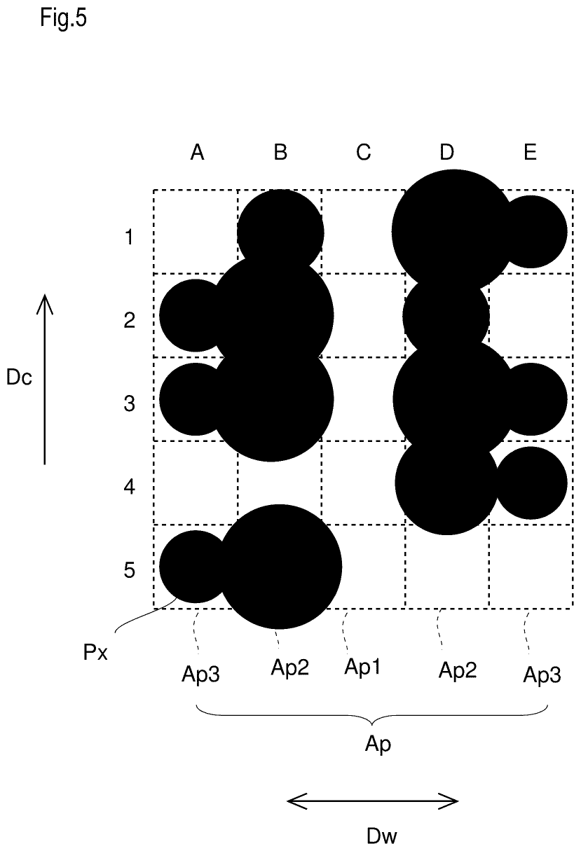

FIG. 4 is an explanatory view showing ink ejection positions, and FIG. 5 is an explanatory view showing ink-drop positions on a paper sheet. More specifically, FIGS. 4 and 5 show ink ejection positions in a case where fourteen pixels Px are recorded in twenty-five pixel areas Ap ranging from the 1st row of column A to the 5th row of column E. The sheet conveyance direction Dc is a direction directed from below toward above in FIGS. 4 and 5, where the lower side in FIGS. 4 and 5 corresponds to the upstream side of the sheet conveyance direction Dc, and the upper side corresponds to the downstream side of the sheet conveyance direction Dc.

A Iso in FIGS. 4 and 5, each pixel area Ap denotes a virtual area derived from classifying image recording areas of the sheet S by resolution. Although pixel areas are depicted by broken-line rectangular shapes in FIGS. 4 and 5, yet such broken-line rectangular shapes are not recorded on the actual sheet S. The controller 7 transmits an ink ejection control signal to recording heads 51 each time the sheet S moves in a unit of resolution along the sheet conveyance direction Dc. As a result, the recording heads 51 eject ink toward pixel areas on the sheet S. Pixels Px are elements of an image recorded by ink drops ejected in correspondence to individual image areas, respectively, thus being component elements in minimum units of images.

In this embodiment, nozzles 52 that eject ink to columns A, C, and E out of the pixel areas Ap belong to a preceding-shot nozzle group, while nozzles 52 that eject ink to columns B and D out of the pixel areas Ap belong to a succeeding-shot nozzle group. Nozzles 52 belonging to the preceding-shot nozzle group, and nozzles 52 belonging to the succeeding-shot nozzle group, are placed alternately in the sheet widthwise direction (intersectional direction) Dw.

Nozzles 52 belonging to the preceding-shot nozzle group eject ink drops prior to nozzles 52 belonging to the succeeding-shot nozzle group. That is, after ink drops have been ejected from nozzles 52 belonging to the preceding-shot nozzle group, ink drops are ejected from nozzles 52 belonging to the succeeding-shot nozzle group at a timing when the sheet S is completely moved over a transition between the nozzles 52 belonging to the preceding-shot nozzle group and the nozzles 52 belonging to the succeeding-shot nozzle group.

The recording heads 51B, 51C, 51M, 51Y eject, from nozzles 52 onto the sheet S, ink drops corresponding to the four colors of black (B), cyan (C), magenta (M), and yellow (Y), respectively. Making relative movement between the sheet S and the recording heads 51 allows an image composed of ink drops to be formed on the sheet S.

With the inkjet recording apparatus 1 according to this embodiment, in cases where a nozzle 52 belonging to a preceding-shot nozzle group has incurred non-ejection or other faults, the controller 7 makes correction by changing ejection quantity of ink drops ejected from nozzles 52 in vicinity of the faulty nozzle 52.

M ore specifically, for example, when a nozzle 52 corresponding to a faulty pixel area Ap1 of column C has incurred a fault such as non-ejection, the controller 7 changes over the quantity of ink ejection to corrective pixel areas Ap2 of column B and column D adjacent in the sheet widthwise direction (intersectional direction) Dw to pixel areas Ap1, respectively, of column C to which ink drops are to be ejected. Also, the quantity of ink ejection to the individual corrective pixel areas Ap2 of column B and column D is changed over depending on whether or not ink drops have already been ejected, i.e. precedently shot, to adjoining pixel areas Ap3 of column A and column E. The adjoining pixel areas Ap3 of column A and column E are oppositely adjacent to the individual faulty pixel areas Ap1 of column C with the corrective pixel areas Ap2 of column B and column D interposed therebetween in the sheet widthwise direction (intersectional direction).

In more detail, the quantity of ink ejection to each corrective pixel area Ap2 of column B and column D involved in a case where ink drops have already been ejected, i.e. precedently shot, to the adjoining pixel areas Ap3 of column A and column E is larger than the quantity of ink ejection to each corrective pixel area Ap2 of column B and column D involved in another case where ink drops have not yet been ejected to the adjoining pixel areas Ap3 of column A and column E.

In this embodiment, levels of increases and decreases in ink ejection quantity is changeable in four steps. Also, the ink ejection quantity is determined depending on the size of ink drops (pixels). That is, a pixel Px recorded by a large-size ink drop involves the largest ink ejection quantity, with the ink ejection quantity decreasing more and more for middle- and small-size in this order. In addition, in terms of ink ejection quantity, there are states involving no ink drops. Accordingly, the ink ejection quantity is provided for recording in four steps including the no ink-drop state. Also, size of ink drops (pixels), not being limited to three steps, may be set to other plural steps such as five steps. It is noted that the larger the size of ink drops, the higher the pixel density.

Ink ejection positions and ink drop sizes associated with a plurality of pixel areas Ap are determined based on image data to be recorded on the sheet S. In this embodiment, ink is ejected to positions including 2nd row of column A, 3rd row of column A, 5th row of column A, 1st row of column B, 2nd row of column B, 3rd row of column B, 5th row of column B, 1st row of column D, 2nd row of column D, 3rd row of column D, 4th row of column D, 1st row of column E, 3rd row of column E, and 4th row of column E. In addition, the ink ejection pattern of this embodiment is only an example, so the disclosure is not limited to this.

When nozzles 52 corresponding to individual faulty pixel areas Ap1 of column C are faulty due to non-ejection or the like, no ink is ejected to the individual faulty pixel areas Ap1 of column C. Also, large-size ink drops are ejected to corrective pixel areas Ap2 positioned at 2nd row of column B, 3rd row of column B, 5th row of column B, 1st row of column D, 3rd row of column D, and 4th row of column D. Also, middle-size ink drops are ejected to corrective pixel areas Ap2 positioned at 1st row of column B and 2nd row of column D. Further, small-size ink drops are ejected to adjoining pixel areas Ap3 positioned at 2nd row of column A, 3rd row of column A, 5th row of column A, 1st row of column E, 3rd row of column E, and 4th row of column E.

When ink is ejected based on the ink ejection positions and the ink drop sizes associated with the plurality of pixel areas Ap determined as described above (see FIG. 4), pixels Px are actually recorded like on-sheet ink drop positions shown in FIG. 5.

The pixels Px positioned at 2nd row of column B, 3rd row of column B, 5th row of column B, 1st row of column D, 3rd row of column D, and 4th row of column D are recorded at positions nearer to the pixels Px positioned at 2nd row of column A, 3rd row of column A, 5th row of column A, 1st row of column E, 3rd row of column E, and 4th row of column E, respectively, which are adjacent in the sheet widthwise direction Dw. This is caused by a phenomenon that ink drops of the corrective pixel areas Ap2 are pulled, by ink-shot interference, nearer to ink drops of the adjoining pixel areas Ap3 that have been ejected precedently onto the sheet S.

On the other hand, the pixels Px positioned at 1st row of column B and 2nd row of column D are not recorded nearer to the adjoining pixel areas Ap3 positioned at 1st row of column A and 2nd row of column E, respectively, that are adjacent in the sheet widthwise direction Dw. That is, ink drops of the corrective pixel areas Ap2 are less likely to be pulled nearer to adjoining pixel areas Ap3 to which ink drops have not yet been ejected.

In this embodiment, quantity of ink ejection to the corrective pixel areas Ap2 of column B and column D to be succeedingly shot is changed depending on whether or not ink drops have already been ejected to the adjoining pixel areas Ap3 of column A and column E that have been precedently shot.

In more detail, large-size ink drops are ejected to the corrective pixel areas Ap2 positioned at 2nd row of column B, 3rd row of column B, 5th row of column B, 1st row of column D, 3rd row of column D, and 4th row of column D. Meanwhile, middle-size ink drops are ejected to the corrective pixel areas Ap2 positioned at 1st row of column B and 2nd row of column D.

Accordingly, the quantity of ink ejection to the corrective pixel areas Ap2 differs from the quantity of ink ejection to the adjoining pixel areas Ap3. Also, the quantity of ink ejection to the corrective pixel areas Ap2 involved in a case where ink drops have already been ejected to the adjoining pixel areas Ap3 adjacent in the intersectional direction Dw is two-step higher than the quantity of ink ejection to the adjoining pixel areas Ap3; whereas the quantity of ink ejection to the corrective pixel areas Ap2 involved in another case where ink drops have not yet been ejected to the adjoining pixel areas Ap3 adjacent in the intersectional direction Dw is higher by one step than the quantity of ink ejection to the adjoining pixel areas Ap3.

Therefore, by ejecting large-size ink drops to the corrective pixel areas Ap2, which are more susceptible to ink-shot interference, pixels Px of large drop diameters are recorded by large-size ink drops even when ink drops have shifted toward the adjoining pixel areas Ap3. As a result of this, part of the pixels Px overflows the corrective pixel areas Ap2, covering part of the faulty pixel areas Ap1. Thus, generation of white stripes in the faulty pixel areas Ap1 can be reduced.

Meanwhile, by ejecting middle-size ink drops to the corrective pixel areas Ap2, which are less susceptible to ink-shot interference, generation of black stripes in the corrective pixel areas Ap2 can be reduced. Further, ink consumption can also be suppressed.

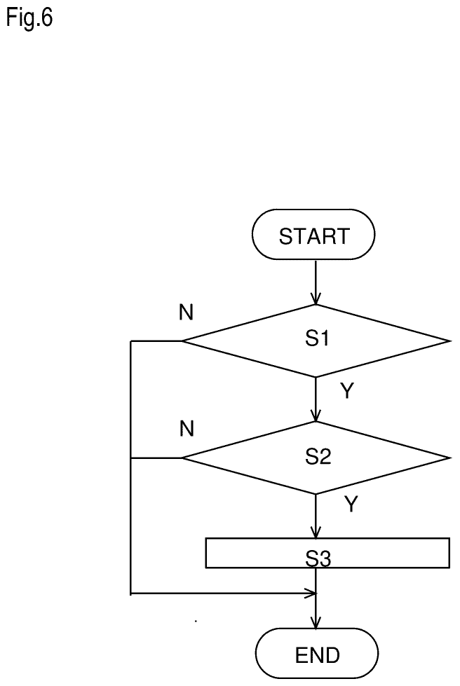

FIG. 6 is a flowchart showing an execution example of image processing with the inkjet recording apparatus 1. In this embodiment, a correction mode is executable in which a drive condition for the recording heads 51 under execution of a normal recording mode is corrected. Upon execution of the correction mode, it is detected whether or not any nozzle 52 has incurred a fault such as non-ejection or the like (step S1).

More specifically, a check chart (not shown) for detection of any faulty nozzle 52 is recorded on a sheet S, and the check chart recorded on the sheet S is optically read by an image reader (not shown). Subsequently, recording data responsive to the read image is generated, followed by detection of a faulty nozzle 52 based on the recording data. On condition that a faulty nozzle 52 has been detected (YES at step S1), the faulty nozzle 52 is specifically determined and stored in the storage part 8.

At step S2, it is decided whether or not the specifically determined faulty nozzle 52 belongs to the preceding-shot nozzle group. On condition that the faulty nozzle 52 belongs to the preceding-shot nozzle group (YES at step S2), the processing moves on to step S3.

At step S3, a drive condition for the recording heads 51 is corrected. As a result of this, the quantity of ink-drop ejection from nozzles 52 in vicinity of the faulty nozzle 52 is corrected. The corrected drive condition for the recording heads 51 is stored in the storage part 8. As a consequence, during execution of the normal recording mode, an image is formed based on the corrected drive condition for the recording heads 51. Thus, generation of white stripes and black stripes (color stripes) can be reduced during execution of the recording mode.

Next, an evaluation was made as to whether or not generation of image faults could be suppressed by correcting the quantity of ink-drop ejection from nozzles 52 in vicinity of the faulty nozzle 52.

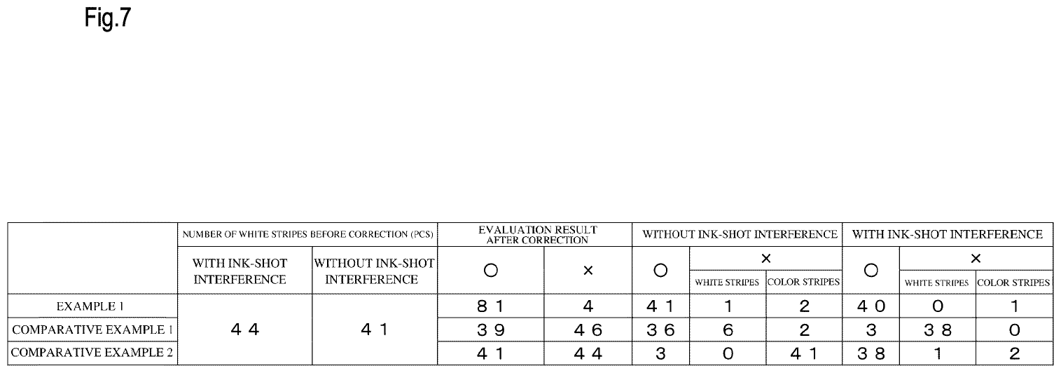

As a mode of evaluation, the quantity of ink ejection to corrective pixel areas Ap2 was changed for eighty-five faulty nozzles 52 belonging to the preceding-shot nozzle group in evaluations of Example 1, Comparative Example 1, and Comparative Example 2. Under this condition, numbers of generated white stripes and color stripes were counted and listed in a table of FIG. 7.

In the evaluation of Example 1, large-size ink drops were ejected to the corrective pixel areas Ap2 in a case where ink drops had already been ejected, i.e. precedently shot, to adjoining pixel areas Ap3. Also, middle-size ink drops were ejected to the corrective pixel areas Ap2 adjacent in the sheet widthwise direction Dw in another case where ink drops had not yet been ejected to the adjoining pixel areas Ap3.

Further, in the evaluation of Comparative Example 1, in a case where ink drops had already been ejected, i.e. precedently shot, to the adjoining pixel areas Ap3, and in another case where ink drops had not yet been ejected to the adjoining pixel areas Ap3, middle-size ink drops were ejected to the corrective pixel areas Ap2 adjacent in the sheet widthwise direction Dw. In this case, the size of ink drops to be ejected to the corrective pixel areas Ap2 becomes the middle size irrespective of whether or not ink drops have already been ejected to the adjoining pixel areas Ap3.

Still further, in the evaluation of Comparative Example 2, in a case where ink drops had already been ejected, i.e. precedently shot, to the adjoining pixel areas Ap3, and in another case where ink drops had not yet been ejected to the adjoining pixel areas Ap3, large-size ink drops were ejected to the corrective pixel areas Ap2 adjacent in the sheet widthwise direction Dw. In this case, the size of ink drops to be ejected to the corrective pixel areas Ap2 becomes the large size irrespectively of whether or not ink drops have already been ejected to the adjoining pixel areas Ap3.

In evaluations as to whether or not generation of image faults could be suppressed, image data were recorded under drive conditions for the recording heads 51, respectively, followed by observing whether or not white stripes or color stripes were found in the after-recording image data. Cases in which neither white stripes nor color stripes were generated were decided as favorable ‘o’ (favorable), and cases in which white stripes or color stripes were generated were decided as faulty ‘x’.

From the table of FIG. 7, in the evaluation of Example 1, it has proved that generation of white stripes and color stripes can be suppressed independent of whether ink-shot interference is involved or not, so that generation of image faults can be reduced. On the other hand, in the evaluation of Comparative Example 1, it has proved that white stripes are more likely to be generated under a condition that ink-shot interference is involved.

Although an embodiment of the present disclosure has been described hereinabove, the scope of the disclosure is not limited to this and may be carried out as it is changed and modified in various ways without deviating from the gist of the disclosure.

The present disclosure is utilizable in inkjet recording apparatuses.

What is claimed is:

1. An inkjet recording apparatus comprising:
a recording head for ejecting ink onto a recording medium;
a drive unit for moving at least one of the recording medium and the recording head; and
a controller for controlling relative movement of the recording medium and the recording head relative to each other to execute recording on the recording medium, wherein
the recording head
includes a plurality of nozzles which are arrayed along an intersectional direction intersecting a relative movement direction of the recording head relative to the recording medium, and which differ in ejection order of ink drops from one another,
for correction of a faulty nozzle of the recording head, the controller changes quantity of ink ejection to corrective pixel areas adjacent in the intersectional direction to a faulty pixel area corresponding to the faulty nozzle, and
a quantity of ink ejection to the corrective pixel areas involved in a case where ink drops have already been ejected to adjoining pixel areas oppositely adjacent to the faulty pixel area with the corrective pixel areas interposed therebetween in the intersectional direction is larger than a quantity of ink ejection to the corrective pixel areas involved in a case where ink drops have not yet been ejected to the adjoining pixel areas.

2. The inkjet recording apparatus according to claim 1, wherein
the quantity of ink ejection to the corrective pixel areas differs from a quantity of ink ejection to the adjoining pixel areas.

3. The inkjet recording apparatus according to claim 2, wherein
the controller is enabled to change the quantity of ink ejection, whichever it is increased or decreased, in three steps or more,
a quantity of ink ejection to the corrective pixel areas involved in a case where ink drops have already been ejected to the adjoining pixel areas adjacent in the intersectional direction is two-step higher than the ink ejection quantity to the adjoining pixel areas, and
a quantity of ink ejection to the corrective pixel areas involved in a case where ink drops have not yet been ejected to the adjoining pixel areas adjacent in the intersectional direction is one-step higher than the quantity of ink ejection to the adjoining pixel areas.
